(19) United States
(12) Patent Application Publication
(10) Pub. No.: US 2008/0110716 A1
(43) Pub. Date: May 15, 2008

(54) CLUTCH DAMPER FOR A CRANKSHAFT

(76) Inventors: Paul John Gelazin, Waterford, MI (US); Gary E. McGee, Oxford, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/748,128

(22) Filed: May 14, 2007

Related U.S. Application Data
(60) Provisional application No. 60/865,198, filed on Nov. 10, 2006.

(51) Int. Cl. F02B 75/06; F16D 13/00

(52) U.S. Cl. 192/70.17; 123/192.1; 180/65.2; 188/379; 903/913

(57) ABSTRACT

A clutch damper includes a one-way clutch in combination with a tuned torsional damper incorporated into an accessory belt pulley assembly configured for mounting to the outboard end of the crankshaft of an internal combustion engine. The clutch damper is advantageously applicable for use with electric hybrid vehicles having automatic engine off periods during normal vehicle operation. The clutch damper permits belt driven accessories to be electrically driven when the engine is off. The damper is tuned to dampen torsional vibration present at the crankshaft, thereby extending the life of the crankshaft and the one-way clutch.

### CROSS REFERENCE TO RELATED APPLICATIONS

This application claims the benefit of U.S. Provisional Patent Application No. 60/865,198, filed Nov. 10, 2006 entitled “CLUTCH DAMPER FOR A CRANKSHAFT” and which is hereby incorporated by reference in its entirety.

### TECHNICAL FIELD

The present invention pertains generally to one-way clutches and tuned torsional damper apparatus and, more particularly, to a one-way clutch coupled to a tuned torsional damper and incorporated into a belt pulley assembly configured and adapted for mounting to the crankshaft of an internal combustion engine.

### BACKGROUND OF THE INVENTION

Various types of one-way clutches are known. One-way clutches transmit rotary torque between two devices in one direction only, permitting the devices to torsionally decouple when the direction of transmitted torque is reversed. In this way the one-way clutch functions as the mechanical equivalent of the electrical diode by transferring power in only one direction. Dry types of mechanical clutches utilize two one-way coupled members conditionally mechanically coupled by one or more mechanical latches, cams or pawl-like mechanisms. The latches in one member of the one-way clutch engage into pockets in the second member of the one-way clutch to selectively transmit applied torque in one direction between the first and second members. When the direction of the applied torque is reversed, the latches disengage permitting the first member to rotate independently from the second member.

An accessory belt pulley mounted to the outboard end of a crankshaft of an internal combustion engine is often subject to rotary vibrations and fluctuations in torque or torque reversals due to the periodic firing of the pistons in the internal combustion engine and their effect on the rotation of the crankshaft. The accessory belt pulley is provided to drive vehicle accessory devices such as the air conditioning compressor and power steering pump using mechanical power siphoned off the crankshaft of the running engine.

Various types of tuned torsional dampers are known which can be adapted to dampen specific frequencies and modes of vibration. Types of torsional dampers include dry types in that they eliminate the need for a damping or elastomeric fluid, as well as various types of wet or elastomeric dampers.

### SUMMARY OF THE INVENTION

A one-way clutch in combination with a tuned torsional damper is incorporated into an accessory belt pulley for mounting to the outboard end of the crankshaft of an internal combustion engine. A primary function of the tuned torsional damper is to damp out vibrations of the engine crankshaft and thereby improve the durability and life of the crankshaft.

Also as described earlier, inertial devices driven by the crankshaft of an internal combustion engine are subject to fluctuations in torque or torque reversals resulting from the operation of the engine; specifically, the crank shaft supplies increased rotational speed and torque during the power stroke of a cylinder and decreases in rotational speed and delivered torque during other strokes of the engine.

Electric hybrid vehicle powertrains are driven by a combination of an internal combustion engine together with one or more electric motor drives powered from an on-vehicle energy storage device such as storage batteries. To improve fuel efficiency, hybrid vehicles are often configured to temporarily shut down the internal combustion engine when the vehicle is decelerating or stopped, for example at a traffic light. During the period the vehicle engine is shut down, it is desirable to maintain the delivery of mechanical power to the vehicle accessory devices driven by the vehicle accessory belt or belts so as to continuously power vehicle accessory belt driven devices such as the power steering pump and air conditioning compressor. To continuously power belt drive accessories while the engine is temporarily shut down, an electric drive motor may be added to the accessory belt path to keep the accessory belt and belt driven devices turning. The electric operation of the engine accessory belt or belts during the period when the vehicle engine is temporarily shut down is enabled by the use of a one-way clutch incorporated into the crankshaft accessory belt pulley which torsionally decouples the belt pulley from the engine crankshaft when the accessory belt is driven by the electric drive motor. The one-way clutch permits the vehicle engine to drive the accessory belt when the engine is operating, while permitting an electric drive motor to continue to drive the accessory belt when the engine is temporarily shut down.

As discussed earlier, inertial devices directly driven by the crankshaft of an internal combustion engine can be subject to fluctuations in delivered torque due to the operation of the engine; specifically, the crank shaft supplies increased rotational speed and torque during the power stroke of a cylinder and decreases in rotational speed and delivered torque during other strokes of the engine. If the driven devices include a one-way clutch such as in the present invention, the useful life of the one-way clutch can be adversely affected by the variations in speed and torque delivered by the crankshaft, especially if the variations in speed cause the mechanical mechanism of the one-way clutch to repeatedly engage and at least partially disengage or ‘chatter’.

Therefore, the disclosed invention is advantageously configured for use in hybrid vehicles in which the accessory belt is driven by a motor such as an electric motor during periods when the vehicle is operating with the vehicle engine temporarily shut down. The belt pulley equipped with the clutch damper of the present invention advantageously permits the accessory belt to be driven while the engine is off and provides a tuned torsional damper to dampen fluctuations in delivered torque to the clutch while the engine is operatively driving the accessory belt.

The above features and advantages as well as other features and advantages of the present invention will be readily apparent from the following detailed description of the best modes for carrying out the invention when taken in connection with the accompanying drawings.

### BRIEF DESCRIPTION OF THE DRAWINGS

FIG. 1 is a front view of a specific embodiment of a clutch damper assembly incorporating an accessory belt pulley with a one-way clutch in combination with a tuned torsional damper in accordance with the disclosed invention;

FIG. 2 is a cross sectional half view of the clutch damper assembly of FIG. 1 taken along cutting line 2-2. The cross sectional half view is split along the axis of rotation 40 which is also the line of symmetry; and

FIG. 3 is a schematic representation of a clutch damper assembly in combination with a vehicle engine and belt driven accessories.

### DESCRIPTION OF THE PREFERRED EMBODIMENTS

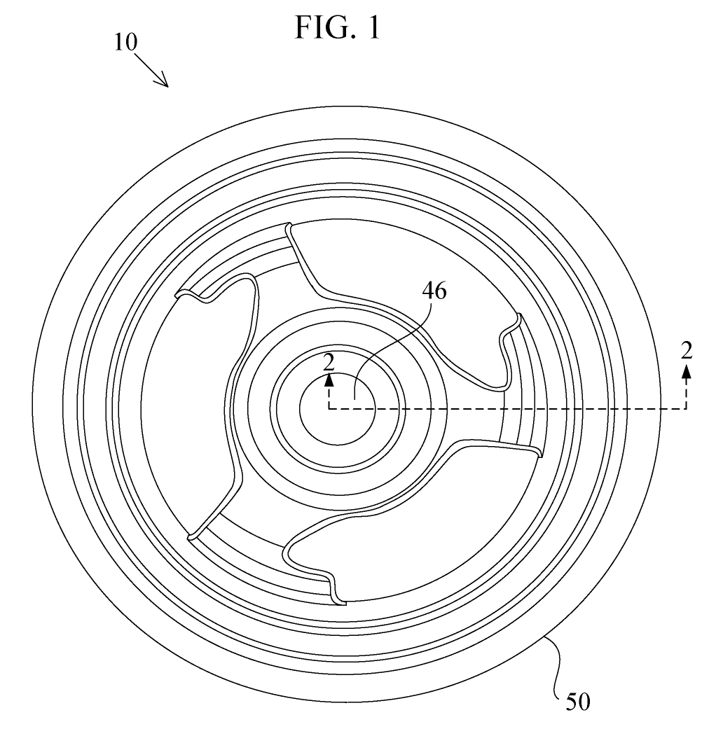

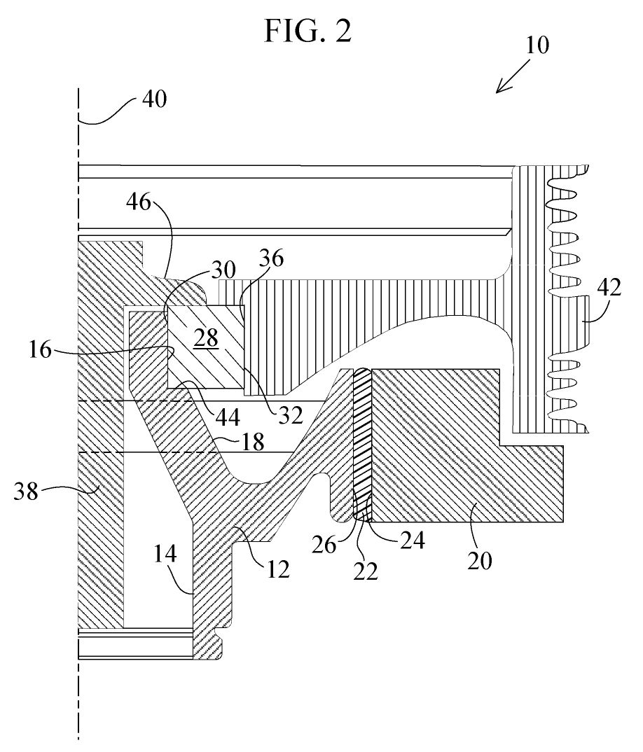

Referring to the drawings wherein like characters represent the same or corresponding parts throughout the several views, there is shown in FIG. 1 a front view of a specific embodiment of an accessory belt pulley incorporating a one-way clutch in combination with a tuned torsional damper, the combination forming a clutch damper assembly 10 in accordance with the disclosed invention. FIG. 2 is a cross sectional half view of the clutch damper assembly of FIG. 1 taken along cutting line ‘2-2’ shown in FIG. 1. The cross sectional half view is split along the axis of rotation 40, which is also the line of symmetry. The half of the belt pulley assembly omitted from the illustration of FIG. 2 is a mirror image of the depicted cross section half view, mirrored about the axis of rotation 40.

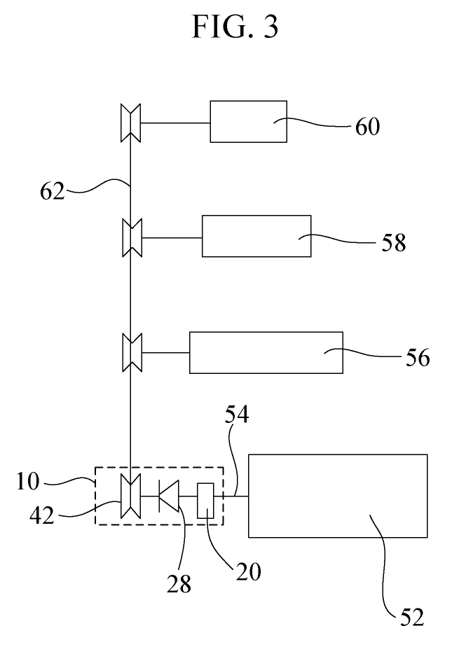

The discussion is now directed to FIGS. 1 and 2 (unless otherwise noted). The clutch damper assembly 10 for a crankshaft 54 (see FIG. 3) of an internal combustion engine 52 (see FIG. 3) includes an annular support hub 12 having an inner annular wall 14 is configured and adapted to be received and secured onto the crankshaft 54 (see FIG. 3) of the vehicle engine 52 (see FIG. 3) for driveably coupling the clutch damper assembly 10 to the crankshaft 54, such that the support hub 12 is torsionally and rotatably driven by the crankshaft 54. The support hub 12 includes an outer annular wall 18 spaced from and surrounding the inner annular wall 14 of the support hub 12. The outer annular wall 18 includes an annular elastomer attachment face 26. An annular ring-shaped tuned torsional inertia damper 20 is received over and surrounds the annular support hub 12 and is positioned proximate to the elastomer attachment face 26. The annular torsional damper 20 has an inner annular face 24 positioned into a confronting alignment with the attachment face 26 of the annular support hub 12. The damper 20 is designed to have a mass and geometry tuned to provide effective damping of the torsional vibration transmitted by the engine crankshaft 54 resulting from the sequential firing of the pistons of the engine 52 during normal operation. A damper elastomer 22 is positioned between and adhesively secures the support hub attachment face 26 to the inner annular face 24 of the annular tuned torsional damper 20. The damper elastomer 22 permanently secures the torsional damper 20 to the support hub 12 and provides for communication of torsional forces between the damper 20 and the support hub 12.

An annular one-way clutch member 28 includes an inner annular drive wall 30 and an outer annular drive wall 32. The clutch 28 is secured to an inner drive wall 36 of the belt pulley 42. Belt pulley 42 surrounds a portion of the support hub 12. The inner annular drive wall 30 of the one-way clutch 28 is sized and adapted to be received over and in confronting proximate relationship to the clutch drive wall 16 of the support hub 12. In the embodiment illustrated in FIG. 2, the clutch 28 is seated on the lip 44 of the support hub 12 and the clutch 28 is mechanically and driveably coupled to the support hub 12 by the compression forces provided by the head 46 of the crankshaft attachment bolt 38 which compressively secures the one-way clutch 28 and its inner annular drive wall 30 to the annular support hub 12.

The clutch damper assembly 10 transmits torque from its input member, the annular support hub 12, to its output member, the belt pulley 42. The annular support hub 12 is operable at a first speed of rotation and the belt pulley 42 is operable at a second speed of rotation. The one-way clutch 28 is adapted to transmit torque in a first torque direction from the input member/support hub 12 to the output member/belt pulley 42 wherein the first and second speeds match and to torsionally decouple when the torque is zero or reverses, thereby permitting the second speed of rotation (the speed of the belt pulley 42) to differ from the first speed of rotation (the speed of the support hub 12). The one-way clutch 28 decouples when the speed of rotation of the belt pulley 42 exceeds the speed of rotation of the support hub 12.

The invention is not limited to the use of the crankshaft attachment bolt 38 to secure and couple the one-way clutch 28 to the support hub 12. The one-way clutch may be coupled between the support hub 12 and the belt pulley 42 using any variety of coupling methods such as but not limited to interference fit, keyway and key, mating splines on the crankshaft 54 and the annular inner wall 14, as well as others as are known to those skilled in the art, moreover, the one-way clutch 28 may be a dry mechanical clutch or a wet clutch.

The belt pulley 42 (see FIG. 2) has an outer wall 50 (see FIG. 1) configured to drive an accessory belt 62 (see FIG. 3) such as, for example, a serpentine belt. The accessory belt 62 (see FIG. 3) is driveably routed to rotatably power various vehicle driven accessories which may include an air conditioning compressor, power steering pump and other devices.

FIG. 3 is a schematic representation of a clutch damper assembly 10 in combination with a vehicle engine 52, electric drive motor 56 and belt driven accessories herein represented by the air conditioning compressor 58 and power steering pump 60. The clutch damper assembly 10 includes a tuned torsional damper 20 which is driven by the crankshaft 54 of the vehicle engine 52. A one-way clutch 28, as described earlier, transmits rotary motion and torque in a first direction from the crankshaft 54 to the belt pulley 42 and is configured to torsionally decouple when the torque transmitted by the one-way clutch 28 from the crankshaft 54 is zero or reverses, permitting the belt pulley 42 to rotate at a different speed than the crankshaft 54 when the one-way clutch 28 decouples. In other words, the belt pulley 42 is free to rotate about the support hub 12 in the normal direction of rotation when the speed of rotation of the belt pulley 42 exceeds the rotation speed of the support hub 12. Belt driven accessories are not limited to the accessories schematically illustrated in FIG. 3, but may instead be any known type of belt drivable accessory including but not limited to compressors, alternators, fans, air pumps, vacuum pumps and other accessories as may be configured to be rotatably powered by a vehicle engine. The accessory belt 62 is flexible and sized to rotatably driveably and torsionally couple the belt pulley 42 of the clutch damper assembly 10 to the electric drive motor 56 and the driven accessories 58 and 60. When the engine 52 is operating, the one-way clutch 28 rotatably and torsionally couples the crankshaft 54 of the engine to the belt pulley 42, permitting the engine 52 to rotatably power the driven accessories (58 and 60). During periods when the vehicle is operating with the engine 52 temporarily shut down, the one-way clutch 28 decouples the belt pulley 42 from the engine crankshaft 54 permitting the electric drive motor 56 to rotatably power the belt driven accessories (58 and 60) independently of the engine 52 and crankshaft 54.

The clutch damper assembly 10 as disclosed herein can be advantageously applied as the crank shaft accessory belt pulley of an electric hybrid vehicle. In hybrid vehicles the engine 52 is typically shut down during periods when the vehicle is decelerating or stopped, for instance at a traffic light. The engine on/off operation provides improvement in vehicle fuel economy. Hybrid vehicles may include an electric motor 56 powered from the vehicle batteries to drive the accessory belt 62 during periods when the vehicle is operating with the vehicle engine 52 temporarily shut down or not operating. The belt pulley 42 equipped with the one-way clutch 28 of the present invention advantageously permits the accessory belt 62 to be driven while the engine is off or not operating. When the engine 52 resumes operation, the one-way clutch 28 torsionally and driveably couples the crankshaft 54 to the accessory belt 62 through the locking action of the one-way clutch 28 of the clutch damper assembly 10. Additionally, the clutch damper assembly 10 provides a tuned torsional damper 20 configured to dampen fluctuations in crankshaft delivered torque to the one-way clutch 28 while the engine 52 is operatively driving the accessory belt 62. Damping fluctuations in crankshaft torque advantageously extends the life of the mechanical latching elements of the one-way clutch 28 as discussed earlier, thereby extending the service life of the clutch damper assembly 10 over similar assemblies which lack a tuned torsional damper 20.

While the best modes for carrying out the invention have been described in detail, those familiar with the art to which this invention relates will recognize various alternative designs and embodiments for practicing the invention within the scope of the appended claims.

1. A clutch damper assembly comprising:
a torque input member operable at a first speed of rotation;
a torque output member operable at a second speed of rotation;
a torsional inertia damper secured to said input member, said damper operable for damping vibration; and
a one-way clutch adapted to transmit rotary motion and torque in a first direction from said input member to said output member, and to torsionally decouple when said torque is zero or reverses from said first direction permitting said second speed of rotation to differ from said first speed of rotation.

2. The clutch damper assembly of claim 1, wherein said damper is secured to said input member by an elastomer, said elastomer adhesively securing said damper to said input member, said elastomer transmitting torque and vibration to said damper.

3. The clutch damper assembly of claim 1, wherein said output member is a belt pulley, said belt pulley configured and adapted to drive an accessory belt.

4. The clutch damper assembly of claim 3, wherein said input member is configured and adapted for driveably coupling said clutch damper assembly to a crankshaft of a vehicle engine.

5. The clutch damper assembly of claim 4, wherein said torsional inertia damper is a tuned damper, said damper having a mass and geometry tuned to provide effective damping of torsional vibration transmitted by said crankshaft, said torsional vibration resulting from operation of said engine.

6. The clutch damper assembly of claim 5, wherein said one-way clutch is a dry mechanical clutch.

7. The clutch damper assembly of claim 5, wherein said one-way clutch is a wet clutch.

8. A clutch damper assembly for a crankshaft of an internal combustion engine, the crankshaft having a normal direction of rotation, said clutch damper comprising:
an annular support hub comprising:
an inner annular wall configured and adapted for securing onto said crankshaft, said annular support hub torsionally and rotatably driven thereby;
an annular clutch drive wall; and
an outer annular wall spaced from and at least partially surrounding said inner annular wall, said outer annular wall including an annular elastomer attachment face;
an annular tuned torsional inertia damper received over and at least partially surrounding said support hub, said damper having an inner annular face in confronting alignment with said elastomer attachment face of said support hub, said damper having a mass and geometry tuned to provide effective damping of torsional vibration transmitted by said crankshaft;
a damper elastomer positioned between and adhesively securing said elastomer attachment face to said inner annular face of said damper, wherein torque is transmitted between said support hub and said damper through said elastomer;
an annular one-way clutch member having an inner annular drive wall and an outer annular drive wall, said inner drive wall of said clutch secured to said clutch drive wall of said support hub, said one-way clutch member adapted to transmit torque between said clutch inner annular drive wall and said clutch outer annular drive wall in one torque direction only; and
an annular accessory belt pulley, said pulley having an inner driven wall and an outer belt drive wall, said inner driven wall of said pulley secured to said outer annular drive wall of said clutch;
wherein said support hub and belt pulley are rotatable in said normal direction,
wherein said support hub is configured to transmit torque to said belt pulley in said normal direction of rotation, and
wherein said belt pulley is free to rotate about said support hub in said normal direction when said pulley speed of rotation exceeds rotational speed of said support hub.

9. The clutch damper assembly for a crankshaft of an internal combustion engine according to claim 8, further comprising:
a crankshaft attachment bolt for securing said support hub to said crankshaft, wherein said bolt additionally compressively secures said one-way clutch to said support hub.

10. A clutch damper assembly in combination with a vehicle engine, an electric motor and driven accessories, comprising:
a clutch damper assembly including:
a tuned torsional inertia damper driveably secured to a crankshaft of said vehicle engine, said damper having a mass and geometry tuned to provide effective damping of torsional vibration transmitted by said crankshaft, said torsional vibration resulting from operation of said engine;
a belt pulley; and
a one-way clutch adapted to transmit rotary motion and torque in a first direction from said crankshaft to said belt pulley when said vehicle engine is operating and to torsionally decouple said one-way clutch from said crankshaft when said torque transmitted by said one-way clutch from said crankshaft is zero or reverses;
wherein said electric motor is operable to rotatably drive said driven accessories when said one-way clutch is decoupled and said vehicle engine is not operating; and
a flexible drive belt sized and adapted to rotatably, driveably and torsionally couple said belt pulley of said clutch damper assembly to said electric motor and said driven accessories,
wherein said tuned torsional damper is adapted to dampen crankshaft vibrations to extend the life of said crankshaft and operating life of said one-way clutch.

11. A clutch damper assembly in combination according to claim 10, wherein the driven accessories comprise:
an air conditioning compressor; and
a power steering pump.
